(19) United States
(12) Patent Application Publication
(10) Pub. No.: US 2018/0332827 A1
(43) Pub. Date: Nov. 22, 2018

(54) Adjustable Combination Animal Collar and Leash

(71) Applicant: Shelton Neffendorf, Fredericksburg, TX (US)

(72) Inventor: Shelton Neffendorf, Fredericksburg, TX (US)

(21) Appl. No.: 15/932,907

(22) Filed: May 16, 2018

Related U.S. Application Data
(60) Provisional application No. 62/507,213, filed on May 16, 2017.

(51) Int. Cl. A01K 27/00

(52) U.S. Cl. CPC A01K 27/004; A01K 27/001; A01K 27/005

(57) ABSTRACT

A combination leash and adjustable animal restraint, namely an animal collar or harness, is described.

### CROSS-REFERENCE TO RELATED APPLICATIONS

The present application is a Non-Provisional Utility patent application claiming benefit of priority of U.S. Provisional Application No. 62/507,213, filed on May 16, 2017, entitled, “ADJUSTABLE COMBINATION ANIMAL COLLAR AND LEASH”, the entire disclosures of which are hereby incorporated by reference.

### BACKGROUND OF THE INVENTION

### (1) Field of Invention

The present invention relates to a domestic animal care and control device, and more particularly to a novel adjustable combination collar and leash for domestic animals. Collars serve many uses for domestic animals, including providing means controlling the animals, for holding medical information and identification tags, and/or may be required by local laws any time the animal is taken out into the public. However, collars can be difficult to put on and take off of the animal, and may need to be replaced as the animal ages and its neck grows larger.

Collars and leashes are often used in combination, but pose additional problems to animal owners. Leashes are often kept separately from the animal's collars and so can be easily separated or lost, and not all leashes have compatible mechanisms to connect them. A leash that is combined with a collar is needed, particularly one that can be easily attached and removed, and is adjustable for use on any size animal, allowing it to be used even as the animal grows bigger.

Thus, the present invention is an improved adjustable collar and leash combination for domestic animals.

### (2) Description of Related Art

Leash and collar apparatus for domestic animals, such as dogs and cats are known in the art. Generally, such products include a collar comprising a band of resilient material, such as leather or a similar synthetic material. The band is typically equipped with a fastener such as conventional metal buckle or a more recently developed plastic buckle with side release, etc. The fastener allows the band to be formed into an endless loop for placement around the neck of the animal. In general, collars bear identifying structures such as a license or owner ill tag, and are worn continuously by the animal.

The second component of such apparatus includes a leash comprising a lead of predetermined length. The lead is affixed at one end with a handle, which may be removable, and at an opposing end with a connector for fixing the lead to the collar when a user wishes to walk in tandem with the animal. Although newer designs of leashes and collars have been developed, including retractable leashes, and collars that constrict under tension, the overall designs of such products have generally remained the same over time.

Conventional leash and collar apparatus have several disadvantages. Primary among these drawbacks is a requirement of repetitively connecting and disconnecting the leash and collar before and after each use. Although leashes and collars are typically equipped with clip-on devices and other fasteners that are relatively easy to use, such as swiveling bolt snaps or spring hooks, or even hook and loop fasteners, the movement of an excited animal relative to a user holding a leash makes employing any type of fastener difficult. Disengaging such a fastener from a collar, while easier than connecting it, presents yet another task associated with use of a conventional leash and collar apparatus, and when compounded with other activities required for walking an animal, can lead to less frequent walks. Additionally, once the need for using the leash has been completed, the animal owner must also decide whether or not to remove the animal's collar, for example once the owner and pet have returned home.

Thus there remains a continuing need for an adjustable collar and leash for use with domestic animals that performs the functions of a conventional leash and collar without the limitations of apparatus currently known in the art. In this respect, the combination leash and collar device taught by the present invention departs from the designs and concepts found in the prior art.

### SUMMARY OF INVENTION

The present invention provides an improved adjustable combination animal collar and leash system. The general purpose of the invention, which will be described subsequently in greater detail, is to provide a new and improved combination dog collar and leash system that eliminates significant drawbacks and disadvantages of the prior art.

To accomplish the foregoing, the present invention comprises a combination animal leash and collar system having means for attaching ID and medical tags and adjustment means that permits easy application and removal of the system from the animal, as well as allowing for use on different sized animals, and on the same animal as it changes in size throughout its life. The invention comprises a single, unitary structure, thereby eliminating the need for fastening or unfastening the leash from the collar. This is accomplished by use of a single cord of material or else a plurality of cords woven or stitched together. Additional materials may be added to the structure, such as padding for comfort added to the animal owner's handle portion or to the front of the animal's neck within the collar portion of the structure. Although the structure is preferably formed in the same material, in various alternative embodiments the collar portion of the structure may be independently constructed out of different materials before being integrated into the structure of the apparatus. The materials used to create the apparatus may also incorporate reinforcements, either in through the use of additional reinforcement materials known to prevent ripping or fraying, or through reinforced stitching, or both.

The handle for the leash portion of the apparatus may be of any size and the leash portion of any predetermined length, and is likely to vary depending on the size and weight of the animal on which the apparatus is to be used. In one embodiment of the invention, the handle is formed at one end of the length of material used in forming the apparatus by looping the material back on itself and then securing the material in place by stitching together a portion of the overlapping sections. This reinforces the structure of the leash portion of the apparatus while creating an appropriate sized handle for use in walking the animal. In an alternative embodiment, where a plurality of cords of material are woven together, the handle is formed by leaving a portion of the length of these materials to remain unattached, creating an opening of a predetermined size to be used to grasp the apparatus when needed in order to lead or otherwise control the animal on which the present invention has been placed.

The collar portion of the apparatus is similarly formed using the materials of the apparatus turned back on themselves. In one embodiment, the material used to form the leash portion of the apparatus terminates in a fork, and the lower portion of the material is used to form an endless loop which connects at the fork and can be placed around the neck of the animal as the collar. A cord lock is then used to enlarge or constrict the loop, allowing the loop to be placed around, or removed from, the animal's neck. At the point where the material forks, a D-ring can be attached to allow for placement of medical information and/or identification tags. When applying the apparatus to the animal, the loop is enlarged to allow the head of the animal to pass through easily, and the cord lock used to contract the loop and tighten the collar to the desired size. While in use, the cord lock engages the material of the apparatus and ensures the circumference of the collar portion of the apparatus remains unchanged, thereby preventing the opening from being enlarged or constricted due to any actions or activities of the animal. Once the apparatus is no longer needed, the cord lock can be reengaged in order to expand the loop in order to allow for easy removal of the collar.

In an alternative embodiment, the collar portion of the apparatus is formed by looping one end of the length of material used in forming the apparatus back on itself and then securing the material in place by stitching together a portion of the overlapping sections. This reinforces the structure of the leash portion of the apparatus while creating an appropriately sized handle for use in walking and/or controlling the animal to which it is applied. At the end of the stitched portion closest to the collar loop, a D-ring is integrated into the stitched section.

A barrel cord lock stopper element is also employed such that the collar loop portion of the apparatus material may slide through the stopper element when not engaged. When not in use, the barrel cord lock stopper rests immediately adjacent to the D-ring, thereby providing for the maximum opening of the collar portion of the apparatus. When in use, the barrel cord lock stopper can be disengaged and will permit the material to pass through it, thereby enlarging and shrinking the collar loop circumference, thereby allowing for easy placement of the collar on the animal and for easy removal once use of the apparatus is no longer required. The D-ring serves a dual purpose in that it is available to hold medical information and/or identification tags for the animal being collared, and also restricts movement of the barrel cord lock stopper, thereby limiting how far onto the leash portion of the apparatus it may travel. The barrel cord lock stopper serves to hold the collar loop material in place while the apparatus is in use, keeping the collar loop from constricting too far while the animal is being walked or controlled, so that the collar does not inadvertently choke or otherwise harm the animal. The barrel cord lock also permits one-handed loosening, making removal of the apparatus easier, particularly in cases of emergency.

In alternative embodiment, the leash portion terminates in a body harness for domestic animals, where the barrel cord lock stopper is employed to tighten the harness after being applied to the animal, or loosen the harness so that it can be more easily removed from the animal when not in use.

Finally, as can be appreciated by one in the art, the present invention also comprises a method for using the adjustable combined collar and leash described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 illustrates a perspective view of one embodiment of the adjustable combination animal collar and leash apparatus constructed in accordance with the principles of the present invention.

FIG. 2 is a top-view illustration of a second embodiment of the adjustable combination animal collar and leash apparatus constructed in accordance with the principles of the present invention.

FIG. 3 is a detailed view of FIG. 2 focusing on the adjustable collar portion of the invention.

### DETAILED DESCRIPTION

The present invention relates to a domestic animal care and control device, and more particularly to a novel adjustable combination collar and leash for domestic animals. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. § 112, Paragraph 6. In particular, the use of “step of” or “act of” in the claims herein is not intended to invoke the provisions of 35 U.S.C. § 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

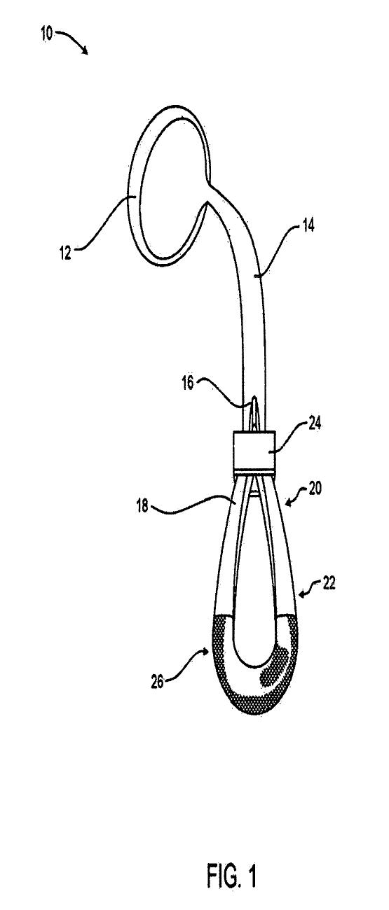

Referring to FIG. 1, one embodiment of the present invention relates to an adjustable combination animal collar and leash apparatus 10 that includes a handle 12 similar to one of more conventional leash handles known in the art. While the handle 12, as illustrated, comprises a loop through which a user may pass the user's fingers and thumb (not shown), the handle 12 may be arranged in any configuration or design suitable for grasping by a user and for secure holding of the apparatus and to control the animal to which it is applied. In various embodiments, the handle 12 may be padded for added comfort, and may be ergonomically designed for a more effective grip and to encourage users to use the apparatus 10 more frequently, which is beneficial to the health of the user and the animal restrained by the apparatus 10.

The handle 12 is connected to an upper lead portion 14, which is similar to a conventional leash and may be of any predetermined length according to preference or as may otherwise be required by law or practice. The upper lead portion 14 is preferably formed of a unitary structure (i.e., made of a single cord of material) or a plurality of cords woven together, as is known in the art. Instead of terminating at a conventional end with a clip, however, the upper lead portion 14 instead terminates at a fork 16. The fork 16 bifurcates the upper lead portion 14, such that below the fork 16 is a lower lead portion 18. The fork 16 is preferably formed in the same material as the upper lead portion 14, but in various alternative embodiments, the upper lead portion 14 and the lower lead portion 18 may be independently constructed, and optionally made of different material, separated by the fork 16.

Preferably, the fork 16 is constructed such that it prevents fraying or ripping into the upper lead portion 14, and the fork 16 may include reinforced stitching or other material suitable for such a purpose. In one alternative embodiment, the upper lead portion 18 may terminate in a connector (not shown) opposite the fork 16, thus allowing the apparatus to be attached to a retractable leash apparatus. In such an embodiment, the handle 12 would be omitted in lieu of the retractable apparatus.

The lower lead portion 18 forms an endless loop, connected at the fork 16. The material comprising the loop of the lower lead portion 18 includes a thin section 20 adjacent the fork 16 and a thickened section 22 opposite the upper lead portion 14. The loop formed by the lower lead portion 18 is preferably sized so that it can easily be installed around the neck of an animal to be walked. For example, in multiple embodiments, the lower lead portion 18 may form a loop of varying sizes to accommodate small, medium, or large animals. Preferably, when two lengths of the thin portion 20 are aligned together, they are substantially the same thickness as the upper lead portion 14 to accommodate smooth transitional movement of a cord lock 24 from the lower lead portion 18 to the upper lead portion 14 and vice versa.

The cord lock 24 is generally installed near the fork 16, and is capable of sliding along the upper lead portion 14 and the thin section 20 of the lower lead portion 18. Since the cord lock 24 encircles the upper lead portion 14, as it crosses over the fork 16 and down over the lower lead portion 18, it brings together two opposing lengths of the thin section 20, thus constricting the loop formed by the lower lead poi lion 18.

The cord lock 24 is configured to lock in a desired position along the upper lead portion 14 or lower lead portion 18, thus enabling a user to move it up along the upper lead portion 14 when the apparatus 10 is not in use, and move it down along the lower lead portion 18 to secure an animal in the apparatus 10. Preferably, the cord lock 24 is configured for single-handed operation, and may comprise an actuator (not shown) such as a button or similar feature for disengaging and re-engaging the cord lock 24. In one preferred embodiment, the cord lock 24 may be biased to engage the upper lead portion 14 and lower lead portion 18, and thus is movable only by a user's active disengagement.

The thickened section 22 preferably includes a nylon or similar mesh material 26, including a stretching but resilient mesh material 26, extending around the lower lead portion 18 and distal from the upper lead portion 14. In one embodiment, the nylon mesh material 26 takes up about half of the loop of the lower lead portion 18 and comprises a padded layer for added comfort of the animal. In an alternative embodiment, the mesh material 26 extends sufficiently over the lower lead portion 18 such that the cord lock 24 extends up to or slightly over the mesh material 26 when the apparatus 10 is installed on an animal. In this manner, the entire neck of the animal is protected by the padded mesh material 26.

In one contemplated alternative embodiment, the apparatus 10 is designed for attachment to a conventional retractable leash. In such an embodiment, the handle 12 is preferably omitted entirely and the upper lead portion 14 may be truncated according to preference, or also omitted entirely. A clip attachment (not shown) is affixed to the truncated end of the upper lead portion 14 or just above the fork 16 and connects to a complimentary attachment customarily included with retractable leashes. In such an embodiment, the user adjusts the cord lock 24 on the lower lead portion 18 to secure the collar, and uses the retractable leash to lengthen and shorten the lead length between the user and an animal wearing the apparatus 10.

The structure of the apparatus 10 in this embodiment having been shown and described, its method of operation will now be discussed.

In order to employ the apparatus 10, a user retrieves the apparatus 10 from a place of storage. When obtaining a new apparatus 10 from its packaging, or after a prior use, the cord lock 24 is preferably locked in a predetermined position somewhere along the upper lead portion 14 above the fork 16, thus allowing the lower lead portion 18 to present a loop of maximum circumference. The large circumference loop formed by the lower lead portion 18 can be easily placed over an animal's head and come to rest around the animal's neck. The user then disengages the cord lock 24, allowing it to move along the upper lead portion 14, and moves the cord lock 24 onto the lower lead portion 18.

As the cord lock 24 is moved, the loop formed by the lower lead portion 18 constricts, closing the loop and thus the lower lead portion 18 around the animal's neck. Also during this motion, the mesh material 26 of the thickened section 22 is brought closer around the animal's neck. Although the cord lock 24 can be re-engaged and set at any preferred position on the lower lead portion 18, it is anticipated the mesh material 26 and thickened section 22 will extend sufficiently around the lower lead portion 18 to enclose the animals neck entirely with the padded mesh material 26 for comfort. Since animals on leashes have a tendency to move forward of the user when walking, a user may prefer to leave the cord lock higher on the lower lead portion 18 resulting in a larger open loop, in which case forward strain against the lower lead portion 18 will also be solely against the padded mesh material 26. In any event, the cord lock 24 enables the creation of virtually any sized loop of the lower lead portion 18 according to preference.

With the apparatus 10 installed on an animal, the user may walk the animal according to custom, with the animal comfortably constrained by the lower lead portion 18. Upon completion of the walk, the user simply disengages and raises the cord lock 24, typically up to or above the fork 16 along the upper lead portion 14, and allows the apparatus 10 to come away from the animal, with the enlarged loop of the lower lead portion 18 traveling back over the animal's head. The apparatus 10 can then be stored, for example hung on a peg or hook (not shown), until needed again.

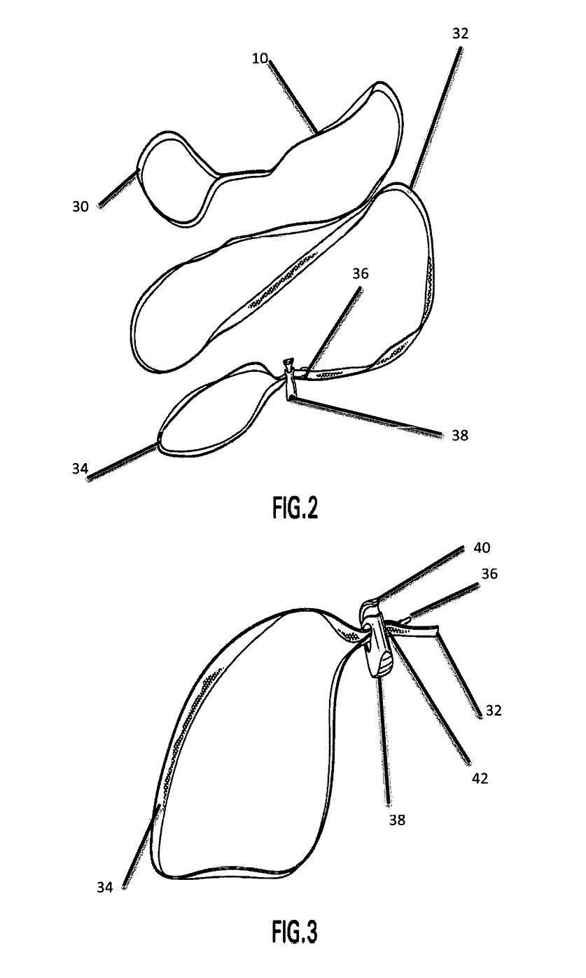

Referring to FIGS. 2 and 3, a second embodiment of the present invention 10 relates to an adjustable combination animal collar and leash apparatus that includes a lead portion 32 connecting a handle 30 and collar loop 34. The lead portion 32 is preferably formed of a unitary structure (i.e., made of a single cord of material) but may also be constructed using a plurality of cords woven together, as is known in the art. The handle 30 and the collar loop 34 are each of a predetermined fixed size and are formed at either end of the lead portion 32 by looping a length of the material back on itself and then securing it in place by stitching together a segment of the overlapping sections of material to form a reinforced connector 42. The length of the reinforced connector 42 is not mandated and can be determined in any reasonable manner, such as based on the materials utilized or the means employed in stitching or otherwise securing the materials to each other.

As used in creating the handle 30, the reinforced connector stabilizes and strengthens the connection between the handle and the lead portion 32. The size of the handle 30 can be formed in any predetermined dimension deemed appropriate for allowing users to walk or otherwise control any type or size of domestic animal. In an alternative embodiment, where a plurality of cords of material are woven together, the handle 30 may be formed by leaving a gap between the plurality of cords being utilized in the construction of the apparatus 10 brought about by allowing a predetermined length of these materials to remain unstitched or otherwise unattached, thereby creating the opening 30 required to grasp the apparatus 10 for leading or otherwise controlling the animal on which it has been placed. In still another alternative embodiment, additional materials may be added to the handle 30 structure, such as padding added for the animal owner's comfort.

In forming the collar loop 34, a D-ring 36 is incorporated into the reinforced connector 42 so that it remains bound in place. The D-ring can be integrated at the start of, end of, or at any point along the length of, the reinforced connector 42, although ideally it is situated near the start of the reinforced connector 42 adjacent to the collar loop 34.

A barrel cord lock stopper 38 is also employed such that the collar loop 34 may slide unimpeded through the barrel cord lock stopper 38 when it is disengaged, but is held tightly in place while the stopper 38 is engaged. The barrel cord lock stopper can be disengaged only by applying downward pressure on the stopper mechanism 40, and is re-engaged once the stopper mechanism 40 is released. When the apparatus 10 is not in use, the barrel cord lock stopper 38 can be disengaged and moved along the length of the collar loop 34 until it is brought to rest immediately adjacent to the D-ring 36, thereby allowing for the maximum opening of the collar loop 34. Once re-engaged, the barrel cord lock stopper 38 holds tightly onto the apparatus 10 material, preventing the barrel cord lock stopper 38 from moving along such material.

When the apparatus 10 is used on an animal, the stopper mechanism 40 is depressed by the user, allowing the barrel cord lock stopper 38 to be disengaged and permitting the collar loop 34 to pass through it, thereby enlarging and shrinking the collar loop circumference, allowing for easy placement of the collar on the animal and for easy removal once use of the apparatus is no longer required.

The D-ring 36 serves a dual purpose in that may be employed to hold medical information and/or identification tags for the animal being collared, and also restricts movement of the barrel cord lock stopper 38, thereby limiting how far onto the lead portion 32 of the apparatus it may travel. The barrel cord lock stopper 38 serves to hold the collar loop 34 in place while the apparatus 10 is in use, keeping the collar loop 34 from constricting too far while the animal is being walked or controlled, so that the collar loop 34 does not inadvertently choke or otherwise harm the animal. The barrel cord lock stopper 38 also permits one-handed loosening of the collar loop 34, making releasing the animal easier, particularly in cases of emergency.

In one alternative embodiment, the collar loop 34 may terminate in a connector (not shown) past the reinforced connector 42, thus allowing the apparatus 10 to be attached to a retractable leash apparatus (not shown). In such an embodiment, the handle 30 and/or lead portion 32 may be omitted in lieu of such retractable apparatus.

In another alternative embodiment, the lead portion 32 connects the handle 30 to a body harness for domestic animals (not shown), where the barrel cord lock stopper 38 is employed to tighten such harness after it is applied to the animal, or to loosen the harness so that it can be more easily removed from the animal when not in use.

The structure of the apparatus 10 in this alternate embodiment having been shown and described, its method of operation will now be discussed.

In order to employ the apparatus 10, a user retrieves the apparatus 10 from a place of storage. When obtaining a new apparatus 10 from its packaging, or after a prior use, the barrel cord lock stopper 38 is resting along the collar loop 34, preferably locked in a position immediately adjacent to the D-ring 36, thereby providing the maximum opening of the collar loop 34. The large circumference collar loop 34 can be easily placed over an animal's head and come to rest around the animal's neck. The user then depresses the stopper mechanism 40 and disengages the barrel cord lock stopper 38, allowing it to move along the collar loop 34 until the collar loop 34 constricts around the animal's neck.

Since animals on leashes have a tendency to move forward of the user when walking, a user may prefer to leave the barrel cord lock stopper 38 higher on the collar loop 34 resulting in a larger open loop. In any event, the barrel cord lock stopper 38 enables the creation of virtually any sized collar loop 34 according to preference.

With the apparatus 10 installed on an animal, the user may walk the animal according to custom, with the animal comfortably constrained by the collar loop 34. Upon completion of the walk, the user simply disengages the barrel cord lock stopper 38, typically up to the start of the reinforced connector 42 or adjacent the D-ring 36, and allows the apparatus 10 to come away from the animal, with the enlarged collar loop 34 traveling back over the animal's head. The apparatus 10 can then be stored, for example hung on a peg or hook (not shown), until needed again.

What is claimed is:

1. An adjustable animal combination collar and leash comprising:
a. a strap formed of a unitary structure having an upper portion, middle portion and lower portion where:
i. at the lower end is a fork that bifurcates the strap; and
ii. the bifurcated ends of the strap form an endless loop;
b. a cord lock having an aperture adjustably disposed along the strap to control the size of the endless loop formed by the bifurcation of the strap.

2. The device of claim 1 wherein at the end of the upper portion is a loop constituting a handle.

3. The device of claim 1 wherein the upper strap portion terminates in a connector for attachment to a retractable leash apparatus.

4. The device of claim 1 wherein said cord lock can be moved along the lower and middle portions of the strap without impediment in order to change the circumference of the endless loop.

5. The device of claim 1 wherein said cord lock contains an actuator for disengaging and re-engaging the cord lock.

6. The device of claim 1 wherein a D-ring is incorporated at the point where the strap forks.

7. An adjustable animal combination collar and leash comprising:
a. a strap formed of a unitary structure having an upper portion, middle portion and lower portion where:
i. at the end of the upper portion is a loop constituting a handle; and
ii. at the lower end is a loop constituting a collar;
b. a cord lock having a strap accepting aperture adjustably disposed along the loop constituting a collar and lower end portion of the strap wherein said cord lock can be moved along the lower end of the strap without impediment in order to change the circumference of the collar loop.

8. The device of claim 7 wherein the cord lock is a barrel cord lock stopper.

9. The device of claim 7 wherein the cord lock is a double barrel cord lock.

10. The device of claim 7 wherein the upper strap portion terminates in a connector for attachment to a retractable leash apparatus.

11. The device of claim 7 wherein the loops are formed by looping the end of the strap back onto itself and fastening the end of the strap to the portion of the strap it overlaps.

12. The device of claim 7 wherein a D-ring is incorporated at the point where the loop constituting a collar is fastened to the strap.

13. An adjustable animal combination collar and animal harness comprising:
a. a strap formed of a unitary structure having an upper portion, middle portion and lower portion where:
i. at the end of the upper portion is a loop constituting a handle; and
ii. at the lower end is an animal harness;
b. a cord lock having a strap accepting aperture adjustably disposed along the animal harness wherein said cord lock can be moved along the harness without impediment in order to change the degree of constriction of the harness.

14. The device of claim 13 wherein the cord lock is a barrel cord lock stopper.

15. The device of claim 13 wherein the cord lock is a double barrel cord lock.
